(19) United States
(12) Patent Application Publication
(10) Pub. No.: US 2026/0316590 A1
(43) Pub. Date: Oct. 15, 2026

(54) A CONTROL SYSTEM FOR A VEHICLE POWERTRAIN

(71) Applicant: JAGUAR LAND ROVER LIMITED, Warwickshire (GB)

(72) Inventors: Manuel VILABOY, Whitley, Coventry, Warwickshire (GB); Matt SULLIVAN, Whitley, Coventry, Warwickshire (GB); Olivier ROQUES, Whitley, Coventry, Warwickshire (GB); Andy JONES, Whitley, Coventry, Warwickshire (GB)

(21) Appl. No.: 19/482,908

(22) PCT Filed: May 13, 2024
(86) PCT No.: PCT/EP2024/063034

§ 371 Date: Nov. 10, 2025

(30) Foreign Application Priority Data
May 11, 2023 (GB) 2306973.5

(51) Int. Cl. B60L 15/20

(52) U.S. Cl. CPC B60L 15/20; B60L 2240/486

(57) ABSTRACT

Aspects of the present invention relate to control of front and rear axles of a vehicle, where the torque applied to at least one of the axles is reversed and so the axle must traverse lash. The axles may be driven such that the two axles do not suffer lash simultaneously, with one axle being driven to provide a compensation torque while the other is in lash. In this way, the movement of a vehicle may be smoother when torque applied to one or more axles is reversed.

### TECHNICAL FIELD

The present disclosure relates to a control system for a vehicle powertrain. Aspects of the invention relate to a control system, to a vehicle, and to a method.

### BACKGROUND

It is known to provide vehicles with separately drivable axles. During a change of torque direction, such as when the vehicle changes from acceleration to deceleration or begins accelerating or reversing, each relevant powertrain may pass through lash. Lash, sometimes called backlash, is where a mechanical system may move without transferring a force to a second part of the system, due to clearance in gears or elasticity in mountings.

Where vehicles are driven with the torque on each axle driven as a proportion of the total torque, both axles may pass through lash at the same time. This may lead to discontinuities in rates of acceleration or braking and may result in a driver experiencing unexpected movement of the vehicle.

It is an aim of the present invention to address one or more of the disadvantages associated with the prior art.

### SUMMARY OF THE INVENTION

Aspects and embodiments of the invention provide a control system, a vehicle comprising the control system, and a method as claimed in the appended claims.

According to an aspect of the present invention there is provided a control system for controlling a drive system of a vehicle comprising a first power source and a second power source, the control system comprising one or more processors collectively configured to: receive a signal indicative of torque demand for the drive system; in dependence on a change in polarity of the signal indicative of torque demand from a first torque demand value having a first polarity to a second torque demand value having a second polarity, determine a torque target profile for the drive system, the torque target profile crossing a lash region defined as a tolerance band about zero torque; and vary a value of a first torque command for the first power source and vary a value of a second torque command for the second power source such that an instantaneous value of the first torque command has the second polarity, before the second torque command enters the lash region; wherein the sum of the first and second torque commands is substantially equal to a concurrent instantaneous value of the torque target profile.

Each power source may be part of a powertrain. The term “powertrain” will generally be understood as a system comprising a power source and a drivetrain, the drivetrain being a subsystem arranged to receive torque from the power source and to transfer the torque to an output device such as a wheel. Each powertrain may drive a wheel of a vehicle or may drive a pair of wheels. For example, a first powertrain may drive a first axle, which may drive the front wheels of a vehicle and the second powertrain may drive a second axle, which may drive the rear wheels of the vehicle. Alternatively, the first and second powertrains may drive separate wheels, such as a first wheel on a left side of a vehicle and a second wheel on a right side of a vehicle.

Powertrains may suffer a discontinuity in a rate of change of torque when passing through lash. In particular, the power source mountings and the gears of the powertrain may suffer lash. With the control scheme of the present invention, when the powertrain including the second power source passes through lash, the first power source may be available to provide a compensation torque. A discontinuity in rate of change of total torque may therefore be reduced. There may therefore be provided a more consistent change in total torque at the wheels on the road, and in the vehicle may accelerate at a constant rate, reducing the time required to alter a speed of the vehicle and/or reducing the maximum instantaneous acceleration.

Terminology referring to a power source or a torque command entering lash, being in a lash region or leaving lash may be interpreted as a power source generating a torque having a magnitude reducing below a lash threshold, a magnitude being maintained below a lash threshold, and a magnitude increasing above a lash threshold respectively. While lash thresholds are commonly symmetrical about the zero-torque point, it will be understood that an asymmetrical lash threshold may also exist and that a lash threshold for a positive torque may be different from a lash threshold for a negative torque. Further, it will be recognised that lash may be found throughout a powertrain, such as in the transmission, the differential, the power source mountings and the driveshaft(s). However, for ease of reference, it may be stated that the power source passes through lash, as opposed to referencing each and every one of the various components of the associated powertrain.

The one or more processors may be collectively configured to: when the first torque command is in the lash region, command a decrease in the rate of change of instantaneous first torque command, and command a corresponding increase in the rate of change of instantaneous second torque command. As the first power source passes through lash, the rate of change of torque may be reduced in order to account for lash in the system and to avoid undesirable variations in torque or damage to the system. In this way, the second power source may compensate for the lash crossing of the first power source, such that an overall rate of change of torque may be substantially constant.

The one or more processors may be collectively configured to: when the second torque command is in the lash region, command a decrease in the rate of change of instantaneous second torque command, and command a corresponding increase in the rate of change of instantaneous first torque command. As the second power source passes through lash, the rate of change of torque may be reduced in order to account for lash in the system and to avoid undesirable variations in torque or damage to the system. In this way, the first power source may compensate for the lash crossing of the second power source, such that an overall rate of change of torque may be substantially constant.

The one or more processors may be collectively configured to: vary the first torque command for the first power source in accordance with a first torque profile; and/or vary the second torque command for the second power source in accordance with a second torque profile. The torque commands may be based on predefined profiles or ad-hoc algorithms. By using a torque profile, the torque produced by the first and/or second power source may be varied in order to provide a rate of change of torque that allows improved control of the vehicle.

The first torque command may be outside the lash region before the second torque command enters the lash region. In this way, the first power source may be used more effectively to compensate for the second power source passing through lash.

The first torque command may be maintained outside the lash region while the second torque command is in the lash region. In this way, the first power source may compensate for the lash of the second power source for the entire time period that the second power source is in lash.

The one or more processors may be collectively configured to increase the first torque command from a zero-torque state in response to receiving the signal indicative of the torque demand. In particular, in cases where a steady state torque is provided by one power source only, the otherwise undriven power source may be used to compensate for the driven power source passing through lash.

The one or more processors may be collectively configured to: vary the first torque command from a value having the first polarity in response to receiving the signal indicative of torque demand. In this case, both power sources may be commanded in a steady state to generate a torque in the same direction. And both may pass through lash as their torque direction is reversed.

The one or more processors may be collectively configured to maintain the second torque command outside the lash region while the first torque command is in the lash region. In this way, the two power sources may pass through lash at different times, with each power source being maintained outside the lash region while the other is in it, such that each may provide a compensation torque for the other.

The one or more processors may be collectively configured to: in response to receiving the signal indicative of torque demand, maintain the second torque command at a constant value until the first torque command enters the lash region. This allows the second torque command to be maintained at a distance from the lash region, such that the second torque command can vary with a high rate of change of torque while the first torque command is in the lash region, without the second torque command entering the lash region. This allows a continuous rate of change of total torque.

The control system comprises one or more controllers collectively comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to carry out the operation of the control system as defined with reference to the above-described aspect of the invention.

According to a further aspect of the invention, there is provided a vehicle comprising: the control system of the above-described aspect, the first power source, the second power source, a first axle driven by the first power source, and a second axle driven by the second power source.

According to a still further aspect of the invention, there is provided a method of controlling a drive system of a vehicle, the vehicle having a first power source and a second power source, the method comprising: receiving a signal indicative of a torque demand for the drive system; in dependence on a change in polarity of the signal indicative of torque demand from a first torque demand value having a first polarity to a second torque demand value having a second polarity, determining a torque target profile for the drive system, the torque target profile crossing a lash region defined as a tolerance band about zero torque; and varying a value of a first torque command for the first power source and vary a value of a second torque command for the second power source such that an instantaneous value of the first torque command has the second polarity, before the second torque command enters the lash region; wherein the sum of the first and second torque commands is substantially equal to a concurrent instantaneous value of the torque target profile.

According to a still yet further aspect of the invention, there is provided computer readable instructions and/or a computer program or computer program signal which, when executed by a computer, are arranged to perform a method according to the still further aspect of the invention.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle in accordance with embodiments of the invention;

FIG. 2 shows a schematic diagram of a control system and powertrains of a vehicle in accordance with embodiments of the invention;

FIG. 3 shows a graph of torque against time for a known powertrain control scheme;

FIG. 4 shows a graph of torque against time for a powertrain in accordance with an embodiment of the invention;

FIG. 5 shows a graph of torque against time for a powertrain in accordance with an embodiment of the invention

FIG. 6 shows a graph of torque against time for a powertrain in accordance with an embodiment of the invention; and

FIG. 7 shows a flowchart illustrating a method in accordance with embodiments of the invention.

### DETAILED DESCRIPTION

Embodiments of this invention relate to a control system for controlling power sources during periods of time where the direction of torque generated by said power sources is reversed. In particular, the invention relates to lash in powertrains and to ensuring that the power sources pass through lash at different times during torque reversal in order to provide a consistent rate of change of overall torque for a vehicle.

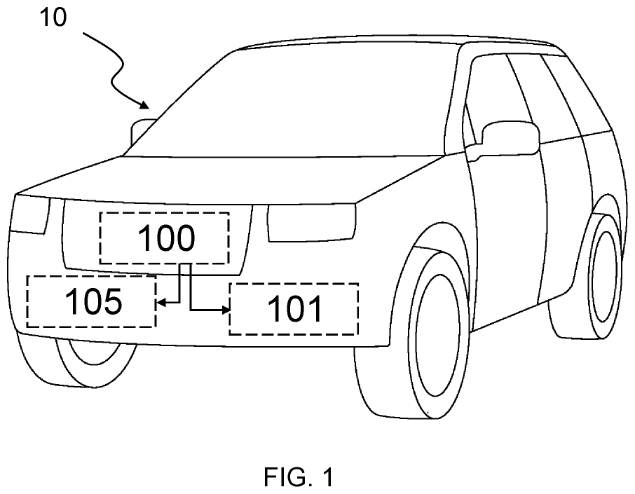

FIG. 1 illustrates a vehicle according to an embodiment of the present invention to provide context for the invention.

The vehicle 10 includes a control system 100, which is arranged to control two powertrains 101, 105. The vehicle 10 may have two driven axles, each powered by one of the powertrains 101, 105, such that the axles may be driven separately and independently.

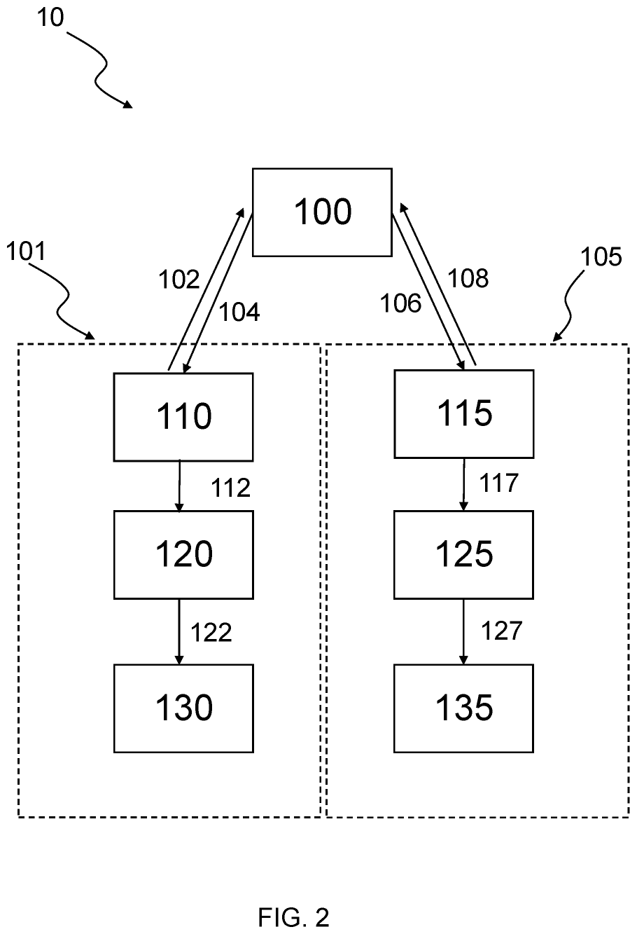

FIG. 2 shows a schematic diagram of the control system 100 and powertrains 101, 105 of the vehicle 10.

The vehicle 10 has a first powertrain 101 for driving a front axle 130 and a second powertrain 105 for driving a rear axle 135. The first powertrain 101 comprises a power source 110, which may be an electric machine, a gearbox 120, which is arranged to receive torque from the power source 110, and an axle 130 that is arranged to drive the wheels of the vehicle 10. It will be understood that the powertrain 101 may comprise further components such as a differential and may comprise more than one axle, such as two stub axles, each axle driving one wheel of the vehicle. It is also envisioned that, while references are made to a single powertrain for controlling an axle, such as a single electric machine driving a powertrain to control both front wheels, the two front wheels may be controlled separately via two separate power sources and may have two separate powertrains.

The vehicle also comprises a second powertrain 105 for powering a rear axle 135 of the vehicle. The second powertrain 105 comprises a power source 115, a gearbox 125 arranged to receive torque from the power source 115, and an axle 135 arranged to receive torque from the gearbox 125 and to drive one or more wheels of the vehicle. Again, similarly to the first powertrain 101, the second powertrain 105 may comprise more than one power source and/or more than one axle as well as further components such as a differential.

The control system 100 as illustrated in FIGS. 1 and 2 comprises one controller, although it will be appreciated that this is merely illustrative, and the control system may comprise more than one controller. The controller comprises processing means and memory means. The processing means may be one or more electronic processing device which operably executes computer-readable instructions. The memory means may be one or more memory device. The memory means may be electrically coupled to the processing means. The memory means is configured to store instructions, and the processing means is configured to access the memory means and execute the instructions stored thereon.

The power sources 110, 115 of the powertrains 101, 105 are arranged to communicate with the control system 100, for example. Specifically, the control system 100 may provide torque commands 104, 106 to the power sources 110, 115 to instruct the power sources 110, 115 to produce a certain amount of torque. Further, the power sources 110, 115 may provide information such as rotational speed 102, 108 to the control system 100.

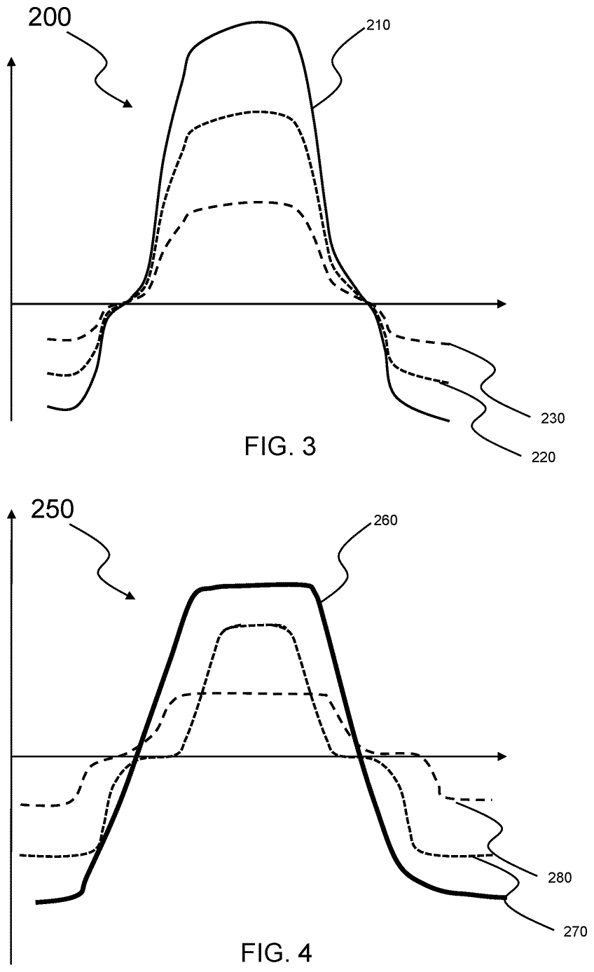

FIG. 3 illustrates a change a variation in torque (τ) over time (t) for a known powertrain control system when a change in torque polarity (for example from a positive polarity to a negative polarity) of two powertrains is instructed. The graph 200 shows a change in overall torque 210 for a vehicle over time. The overall torque 210 is the sum of the torques of a power source associated with a rear axle 220 and a power source associated with a front axle 230. In the known system, the torques applied to the front and rear axles are related by a ratio, which may be maintained substantially constant. Therefore, the torques 220, 230 applied to both axles pass through lash, i.e. have substantially zero torque, at the same time.

When a power source passes through lash, the rate of change of torque for a power source reduces. This may happen naturally due to play or clearance within the system, such as elasticity in the mountings of the power source or a driveshaft, or clearance in joints or gears within the drivetrain. Alternatively, a reduction in a rate of change of torque during lash may be programmed into a control system in order to avoid damage to the system during lash, such as due to uncontrolled movement of the system due to the above-mentioned phenomena.

As a result, it can be seen in FIG. 3 that the overall torque 210 does not vary at a constant rate and the rate of change of overall torque reduces significantly as the two axles pass through lash at the same time L.

By comparison, FIG. 4 illustrates the inventive concept of the present application and shows a graph 250 illustrating a torque of a rear axle 270, a torque of a front axle 280 and an overall torque 260 changing over time. It can be seen that the torques applied to the rear axle 270 and front axle 280 pass through lash, i.e. approximately zero torque, at different times. When changing from a negative torque to a positive torque, the torque applied to the front axle 280 passes through lash first at time L1 and the torque applied to the rear axle 270 passes through lash at a second time L2. When changing back from a positive torque to a negative, the torque applied to the rear axle 270 passes through lash first at time L3 and the torque applied to the front axle passes through later at time L4. Therefore, the rate of change of torque is limited for only one axle at a time, meaning the other axle may have an increased rate of change of torque while the one axle is passing through lash and in this way, it can be seen that the overall rate of change of torque 260 may be substantially constant. As a result, a driver of the vehicle may experience a smoother transition from a positive torque to a negative torque and vice versa. It will be understood that the torque applied to either axle may pass through lash first, and the choice may be made depending on the particular torques applied to each axle before and after the transition.

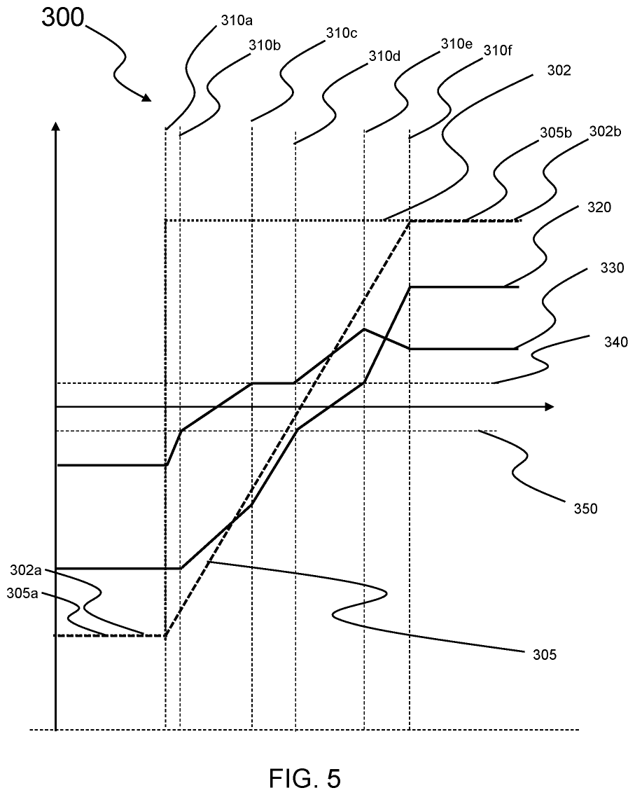

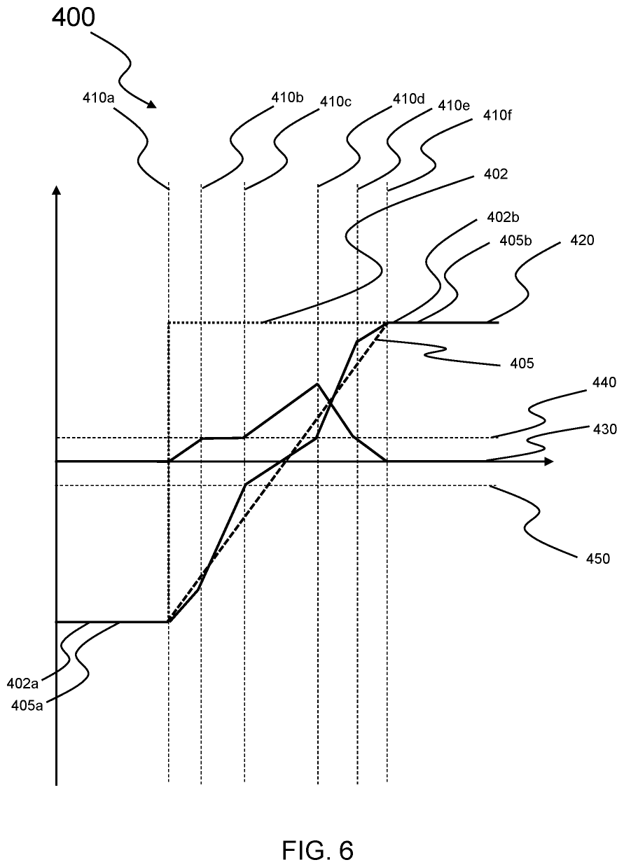

FIGS. 5 and 6 show graphs illustrating how compensation torques to provide consistent rates of change of torque may be provided in more detail in specific situations, in accordance with embodiments of the invention.

FIG. 5 shows a graph 300 illustrating a change in torque commands over time for the power source associated with a rear axle 320 and for the power source associated with a front axle 330. Lash thresholds 340, 350 are shown on the graph 300. A positive lash threshold 340 is a torque level above which a powertrain may be considered outside lash, and a negative lash threshold 350 is a torque level below which a powertrain may be considered outside lash. Generally, the lash region, i.e. the area between the lash thresholds 340, 350, may be considered as a region having a low torque magnitude. The lash region may be defined by a single magnitude and so may be symmetrical about zero torque, or the lash region may be asymmetric as the positive lash threshold 340 and negative lash threshold 350 may have different magnitudes.

FIG. 5 also shows an unfiltered torque demand 302, which may be an input from a driver. A torque profile 305, which may also be referred to as a filtered torque demand 305, is generated based on the unfiltered torque demand. The unfiltered torque demand starts at a first, initial unfiltered torque demand 302a and changes to become a second, final unfiltered torque demand 302b. The generated torque profile 305 starts from an initial, first torque demand value 305a and changes to a final, second torque demand value 305b. It will be understood that the first, initial unfiltered torque demand 302a and the first, initial torque demand 305a may be the same and that the second, final unfiltered torque demand 302b and the second, final torque demand 305b may be the same. The control system may construct the torque profile 305 for changing the overall torque on the system between the initial and final torque values 302a, 302b, based on the unfiltered torque demand 302, at an acceptable rate of change of torque, taking into account driver and passenger comfort as well as vehicle handling and traction requirements.

At a first time, before the time point 310a, the two axles 320, 330 are in a steady state with torque applied to the axles in a fixed ratio. This may allow the control system to manage vehicle traction and efficiency. At time point 310a, a torque demand is received by the system which requires a change in the polarity of the torques delivered by the powertrains. The system may determine at time point 310a that the generated torque profile 302 and the unfiltered torque demand 305 have different polarities. As a result, it is determined that at least one of the axles may change their torque polarity and may therefore pass through lash.

In response to the torque demand, the torque on the front axle 330 is reduced in magnitude, moving towards lash, while the torque on the rear axle 320 is maintained at the previous value. The torque on the rear axle 320 may be reduced during this time period, may be maintained constant or may be increased in magnitude. By maintaining the torque on the rear axle constant during this time period, the rate of change of torque on the rear axle in subsequent time periods for providing a compensation torque may be increased, as the change in torque before lash is maximised. Alternatively, by reducing the torque on the rear axle 320 in this time period, the overall rate of change of torque may be increased, reducing the time required for reaching the final torque demanded by the torque demand.

At time point 310b, the torque on the front axle enters the lash region by being equal to the negative lash threshold 350. Therefore, the rate of change of torque on the front axle 330 is reduced due to the torque on the front axle entering lash. The rate of change of torque on the rear axle 320 is correspondingly increased in order to compensate for the reduction in rate of change of torque on the front axle reducing, such that the overall rate of change of torque remains substantially constant.

At time point 310c, the torque on the front axle 330 leaves the lash region by exceeding the positive lash threshold 340. At this point, the front axle may be considered as preloaded, since the amount of torque on the front axle may be sufficient for the front axle to be reliably controlled and for the torque on the front axle to be increased at a high rate in order to compensate for a reduction in the rate of change of torque on the rear axle. The torque on the front axle is subsequently maintained substantially constant and the rate of change of torque on the rear axle is further increased, until the torque on the rear axle enters lash at time point 310d. It will be understood that between time points 310c and 310d the torques on both axles are outside the lash region and that therefore the rates of change of torque on the axles may be any rate of change of torque.

Due to the rear axle 320 entering lash at time point 310d, the rate of change of torque of the rear axle is reduced and, in order to maintain a consistent rate of change of total torque on the two axles, the rate of change of torque on the front axle 330 is increased, such that the powertrain associated with the front axle provides a compensation torque. During this time period, the torque on the front axle may increase beyond the desired end torque for the front axle. By maintaining the torque on the front axle constant before the rear axle enters lash, the amount of compensation torque that may be provided by the front axle may be increased, without the front axle exceeding a maximum torque for the front axle or the associated powertrain.

At time point 310e, the torque on the rear axle 320 leaves lash by being greater than the positive lash threshold 340. The rate of change of torque on the rear axle 320 may therefore be increased to approach the final torque required on the rear axle 320 in accordance with the final torque demand 305b. The torque on the front axle 330 may be reduced, such that the torque on the front axle may be changed in order to approach a steady state torque on the front axle in accordance with the final torque demand 305b. At time point 310f, the sum of the torques on the front and rear axles may be in line with the torque demand of the system and subsequently the first and second axles may be driven with constant torques.

FIG. 6 shows a further graph 400. The graph 400 illustrates the case where only one axle, for example a rear axle, is driven in a steady state driving mode and a second axle, for example a front axle, is generally undriven but may be used to provide a compensation torque as the driven axle passes through lash.

Similarly to the example shown in FIG. 5, the control system receives an unfiltered torque demand 402, which has an initial, first torque demand 402a and a second, final torque demand 402b and generates a torque profile 405, which may also be referred to as a filtered torque demand 405, based on the unfiltered torque demand 402.

FIG. 6 shows the variation in torque on a rear axle 420 of a vehicle over time, the variation in torque on a front axle 430 of a vehicle over time, and the filtered torque demand 405. The filtered torque demand 405 changes from a first, initial torque 405a to a second, final torque 405b. It will be understood that, as 100% of the torque in the initial and final states is applied via the rear axle 420 that the rear axle torque 420 will equal the torque demand 405 at these times. FIG. 6 also shows lash thresholds 440, 450 which are substantially the same as the lash thresholds described above with reference to FIG. 5.

At a first, steady state time a rear axle 420 is driven and a front axle 430 is undriven. At a time point 410a, the control system receives an unfiltered torque demand 402 and generates a filtered torque demand 405, the torque demand 402 including a change in the polarity of the torque on the rear axle 420. At time point 410a the filtered torque demand 405 has a different polarity from the unfiltered torque demand 402 and so a lash compensation scheme is initiated.

The torque on the rear axle 420 changes in accordance with the torque demand by reducing its magnitude. At the same time, the front axle 430 is driven to leave the lash region, such that the torque on the front axle exceeds the positive torque threshold 440, so that the front axle may subsequently provide a compensation torque at the time that the rear axle enters lash.

At time point 410b, the torque on the front axle leaves the lash region and the front axle is then driven with a constant torque, which may be referred to as a preload torque substantially equal to the positive lash threshold 440, as it is ready to provide a compensation torque at the time when the rear axle enters lash. The rate of change of torque on the rear axle changes at this time to move towards the final torque demand until the torque on the rear axle enters lash at time point 410c.

At time point 410c, the torque on the rear axle 420 enters lash by having a value reducing in magnitude below the magnitude of the negative lash threshold 450. The rate of change of torque on the rear axle 420 therefore reduces and a compensation torque is applied to the front axle 430, as a positive torque, such that the rate of change of total torque stays substantially constant.

At time point 410d, the torque on the rear axle 420 leaves lash by increasing above the positive lash threshold 440 and the rate of change of torque on the rear axle may therefore increase to approach the final torque demand value 405b. At this time, the torque on the front axle may be reduced, to approach the undriven state. During this time period, the torque on neither axle is in lash and so the torque may be varied and a wide range of rates of change of torque may be selected.

At time point 410e, as the torque on the front axle enters lash, having a magnitude below the positive torque threshold 440, the rate of change of torque on the front axle is reduced, and the rate of change of torque on the rear axle may change accordingly in order to maintain a substantially constant rate of change of torque. In some cases, the final torque demand may be reached at time point 410e, and the rates of change of torque on the front and rear axles may be equal and opposite such that there is no change in overall total torque during this time period.

At time point 410f, the front and rear axles may both reach their final required torques and subsequently may be driven with constant torques. Specifically, the front axle may return to an undriven state where the torque on the front axle is nil and the rear axle may be driven with a torque equal to the final demanded torque 405b.

The torques of the power sources may be defined by ad-hoc algorithms based on determinations of the two torques at any point in time, such as by considering whether at least one power source is in lash and considering the polarity of the torques of the power sources. Alternatively, the variations in torque over time may be substantially predetermined based on torque profiles.

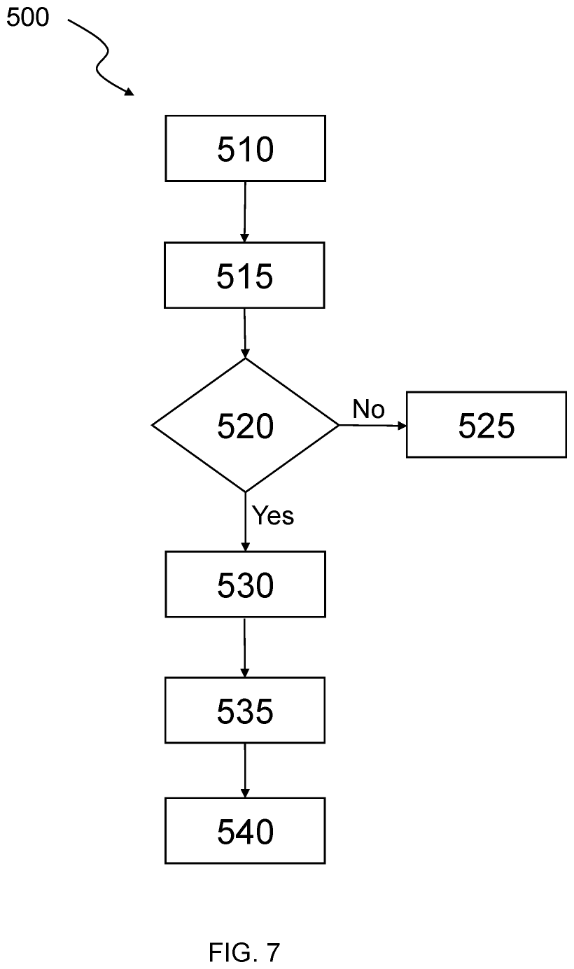

FIG. 7 shows a flow chart 500 illustrating an example method of the present invention.

At step 510 a torque demand is received, requiring a change of torque of one or more of the power sources.

At step 515, the torque demand is filtered to provide a filtered torque demand, which may also be referred to as a torque profile, The filtering may comprise processing the torque demand using a low pass filter or by limiting a rate of change of torque over time. This may improve the traction and composure of the vehicle as well as making the vehicle more comfortable for a driver.

At step 520, it is determined whether the torque demand includes a change in the polarity of the torque generated by one or more of the power sources. The determination may be made based on a difference in polarity of the filtered and unfiltered torque demand. If there is no change in polarity of the torque required, the method moves to step 525, and maintains a fixed ratio of the power sources in order to maintain traction and efficiency as necessary. However, if a change in the polarity of the torque is required, the flow chart moves to step 530.

At step 530, a torque of a first power source is varied in order to have a polarity which is the same as the polarity of the torque demand. During this time period, the second power source may also change its torque, but should not enter a lash region and may provide a compensation torque if the first power source is in the lash region.

After the first power source has obtained the required polarity, and optionally has a magnitude at or above a torque threshold, the method moves to step 535 and the torque of the second power source is varied to achieve the polarity required by the torque demand. Necessarily, the second power source will enter the lash region and during this time a compensation torque is provided by the first power source.

At step 540, dependent on the second power source having the same polarity as the final torque demand, and optionally being outside the lash region and/or within a threshold of its final torque, the first power source may stop providing a compensation torque. The torques of the first and second power sources may therefore move towards their final torque targets, such that the total torque provided by the first and second power sources may equal the final torque demand. Therefore, by the provision of a compensation torque and the two power sources passing through lash at different times, a constant rate of change of total torque may be achieved.

It will be appreciated that various changes and modifications can be made to the present invention without departing from the scope of the present application.

1. A control system for controlling a drive system of a vehicle comprising a first power source associated with a first axle and a second power source associated with a second axle, the control system comprising one or more processors collectively configured to:
receive a signal indicative of torque demand for the drive system;
in dependence on a change in polarity of the signal indicative of torque demand from a first torque demand value having a first polarity to a second torque demand value having a second polarity, determine a torque target profile for the drive system, the torque target profile crossing a lash region defined as a tolerance band about zero torque; and
vary a value of a first torque command for the first power source and vary a value of a second torque command for the second power source such that an instantaneous value of the first torque command has the second polarity, before the second torque command enters the lash region; wherein
the sum of the first and second torque commands is substantially equal to a concurrent instantaneous value of the torque target profile.

2. A control system according to claim 1 wherein the one or more processors are collectively configured to:
when the first torque command is in the lash region, command a decrease in the rate of change of instantaneous first torque command, and command a corresponding increase in the rate of change of instantaneous second torque command.

3. A control system according to claim 1 wherein the one or more processors are collectively configured to:
when the second torque command is in the lash region, command a decrease in the rate of change of instantaneous second torque command, and command a corresponding increase in the rate of change of instantaneous first torque command.

4. A control system according to claim 1, wherein the one or more processors are collectively configured to:
vary the first torque command for the first power source in accordance with a first torque profile; and/or
vary the second torque command for the second power source in accordance with a second torque profile.

5. A control system according to claim 1, wherein the first torque command is outside the lash region before the second torque command enters the lash region.

6. A control system according to claim 5, wherein the first torque command is maintained outside the lash region while the second torque command is in the lash region.

7. A control system according to claim 1, wherein the one or more processors are collectively configured to:
increase the first torque command from a zero-torque state in response to receiving the signal indicative of the torque demand.

8. A control system according to claim 1, wherein the one or more processors are collectively configured to:
decrease the first torque command to a zero-torque state in response to the second torque command leaving the lash region.

9. A control system according to claim 1, wherein the one or more processors are collectively configured to:
vary the first torque command from a value having the first polarity in response to receiving the signal indicative of torque demand.

10. A control system according to claim 9, wherein the one or more processors are collectively configured to:
maintain the second torque command outside the lash region while the first torque command is in the lash region.

11. A control system according to claim 1, wherein the one or more processors are collectively configured to:
in response to receiving the signal indicative of torque demand, maintain the second torque command at a constant value until the first torque command enters the lash region.

12. A vehicle comprising:
the control system of any preceding claim,
the first power source,
the second power source,
a first axle driven by the first power source, and
a second axle driven by the second power source.

13. A vehicle according to claim 12, wherein the first axle is a rear axle of the vehicle and the second axle is a front axle of the vehicle.

14. A method of controlling a drive system of a vehicle, the vehicle having a first power source and a second power source, the method comprising:
receiving a signal indicative of a torque demand for the drive system;
in dependence on a change in polarity of the signal indicative of torque demand from a first torque demand value having a first polarity to a second torque demand value having a second polarity, determining a torque target profile for the drive system, the torque target profile crossing a lash region defined as a tolerance band about zero torque; and
varying a value of a first torque command for the first power source and vary a value of a second torque command for the second power source such that an instantaneous value of the first torque command has the second polarity, before the second torque command enters the lash region;
wherein the sum of the first and second torque commands is substantially equal to a concurrent instantaneous value of the torque target profile.

15. Computer readable instructions which, when executed by a computer coupled to a suitable vehicle, are arranged to perform a method according to claim 14.
